(19) United States
(12) Patent Application Publication
(10) Pub. No.: US 2019/0224877 A1
(43) Pub. Date: Jul. 25, 2019

(54) Hand Guard for Rotational Slicing Type Food Cutting Device

(71) Applicant: Yan Kwong Wong, Hong Kong (HK)

(72) Inventor: Yan Kwong Wong, Hong Kong (HK)

(21) Appl. No.: 15/777,210

(22) PCT Filed: Apr. 28, 2016
(86) PCT No.: PCT/IB2016/052405

§ 371 Date: May 17, 2018

(30) Foreign Application Priority Data
Dec. 7, 2015 (HK) 15112046.2

(51) Int. Cl. B26D 3/26; B26D 5/10

(52) U.S. Cl. CPC B26D 3/26; B26D 2210/02; B26D 5/10

(57) ABSTRACT

A hand guard for rotational slicing type food cutting device is disclosed, which comprises a top cover having a plurality of first baffles having clamping hooks arranged thereon arranged at its bottom circumferentially; a top cover frame having a through hole arranged at its top for allowing the top cover to be inserted; a bottom cover having a nail-shaped object arranged at its bottom and third baffles which are provided with holes to fit the clamping hooks on the first baffles arranged at its top circumferentially; and a spring located between the top cover and the bottom cover. The hand guard can operate in cooperation with the cutting device to enable a user to complete a wrist return action without loosening, thereby preventing deviation between a vegetable-fruit rotation shaft and an axis of the food cutting device, and breakage of food shreds.

### TECHNICAL FIELD OF THE INVENTION

The present invention relates to a mechanical structure of a hand guard for rotational slicing type food cutting device.

### BACKGROUND OF THE INVENTION

When the current rotary slicing type food cutting device is operated, the user needs to rotate the food for cutting while pressing the food into the cone for moving forward. However, due to the limitation of the hand structure, the wrist cannot rotate beyond an angle, it is necessary to release the pressure during the operation to return the wrist to an operable position. But releasing the pressure may cause a deviation between the vegetable-fruit rotation shaft and the axis of the food cutting device, resulting in breakage of food shreds.

### SUMMARY OF THE INVENTION

The features and advantages of the present invention will be illustrated in the subsequent description and become obvious through the description or learnt through implementation of the present invention.

In order to overcome the problems of the prior art, the present invention provides a hand guard for rotational slicing type food cutting device, adopting a top cover and a bottom cover that can be slightly moved up and down so that it is not necessary to release the pressure when the wrist needs to return to the operable posture during operation of the rotary slicing type food cutting device.

The above technical problems of the present invention can be solved by adopting the following technical solution:

According to one aspect of the present invention, a hand guard for rotational slicing type food cutting device is provided, wherein the hand guard comprises: a top cover having a plurality of first baffles having clamping hooks arranged thereon arranged at its bottom circumferentially;
a top cover frame having a through hole arranged at its top for allowing the top cover to be inserted;
a bottom cover having a nail-shaped object arranged at its bottom and third baffles which are provided with holes to fit the clamping hooks on the first baffles arranged at its top circumferentially; and
a spring located between the top cover and the bottom cover.

According to one embodiment of the present invention, the bottom edge of the top cover frame is serrated, the top edge of the bottom cover frame is serrated, and the serration of the bottom edge of the top cover frame matches the serration of the top edge of the bottom cover so that the top cover frame and the bottom cover can rotate clockwise coaxially in the same direction, while when the top cover frame rotates anti-clockwise, the bottom cover remains unmoved.

According to one embodiment of the present invention, second baffles are arranged at the bottom of the top cover circumferentially which are spaced from the first baffles, and are located on the inner side of the second baffles.

According to one embodiment of the present invention, the second baffles and the first baffles are coaxial circles.

According to one embodiment of the present invention, fourth baffles are arranged at the top of the bottom cover circumferentially, which correspond to the second baffles, and are used to support the second baffles to ensure the horizontality of the top cover and its distance from the bottom cover.

According to one embodiment of the present invention, a plurality of support plates is arranged on the inner wall of the through hole of the top cover frame for supporting the top cover.

According to one embodiment of the present invention, a baffle is arranged on the marginal sidewall of the top cover frame, which is provided with a rib on its inner wall for buckled fixation with the upper edge of the food cutting device.

According to one embodiment of the present invention, the top cover, the top cover frame and the bottom cover are arranged coaxially.

Through reading the Description those skilled in the art will better understand the features and contents of these technical solutions.

### BRIEF DESCRIPTION OF THE DRAWINGS

The present invention will be described by referring to the accompanying drawings that illustrate the embodiments of the invention, from which its advantages and realization methods will be evident. The accompanying drawings are intended to illustrate and not to limit the present invention, in which:

FIG. 1 is an exploded view of a hand guard for rotational slicing type food cutting device in an embodiment of the present invention;

FIG. 2 is a front view of the overall structure of a hand guard for rotational slicing type food cutting device in an embodiment of the present invention;

FIG. 3 is a sectional view taken along A-A line of FIG. 2 in the present invention;

FIG. 4 is a side view of the overall structure of a hand guard for rotational slicing type food cutting device in an embodiment of the present invention;

FIG. 5 is a sectional view taken along B-B line of FIG. 4 in the present invention;

FIG. 6 is top view of a bottom cover in an embodiment of the present invention;

FIG. 7 is a schematic view of a top cover frame in an embodiment of the present invention;

FIG. 8 is a schematic view of a top cover in an embodiment of the present invention; and

FIG. 9 is a schematic view a hand guard for rotational slicing type food cutting device in an embodiment of the present invention after it is assembled with a food cutting device.

### DETAILED DESCRIPTION OF THE INVENTIONS

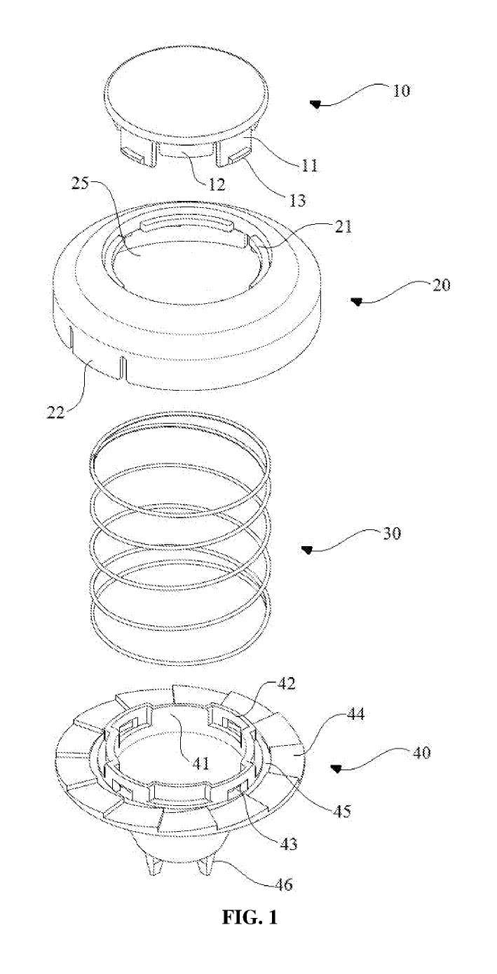

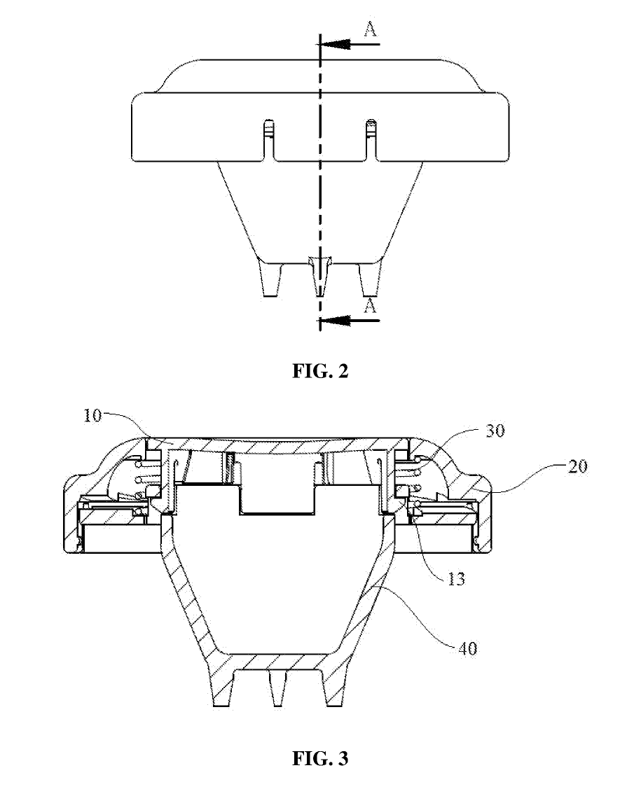

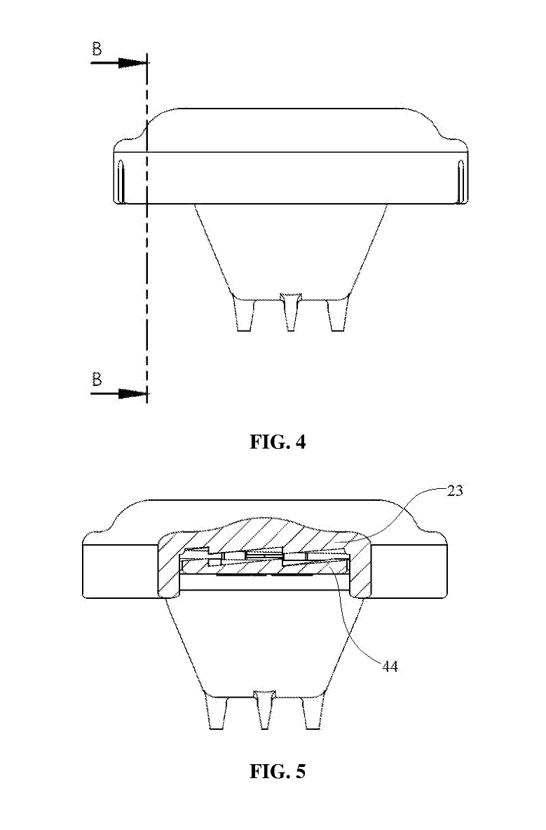

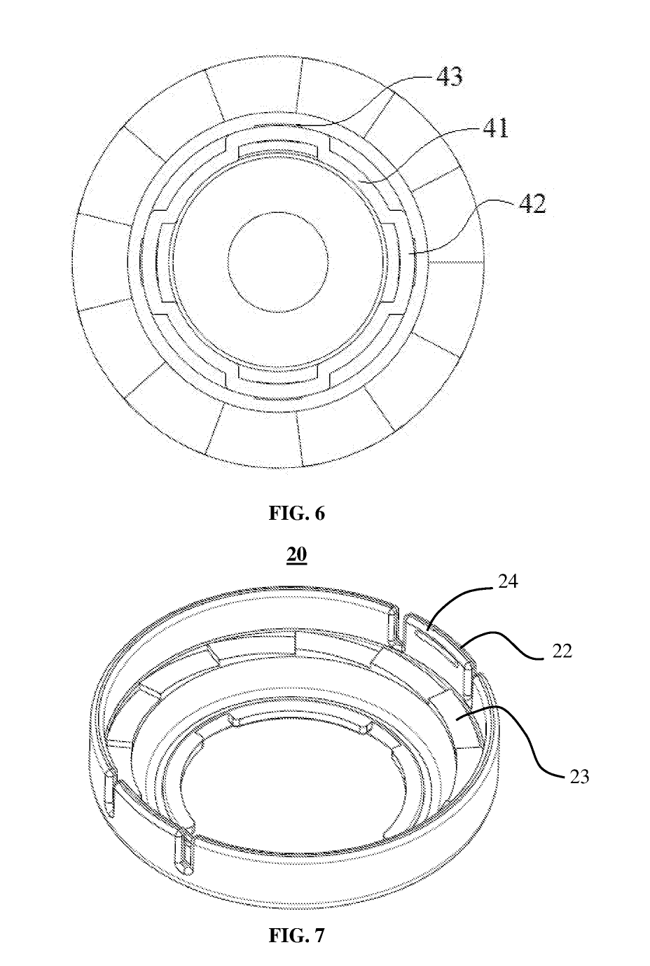

As shown in FIG. 1˜FIG. 7, a hand guard for rotational slicing type food cutting device is disclosed, which comprises a top cover 10 having a plurality of first baffles 11 having clamping hooks 13 arranged thereon arranged at its bottom circumferentially; a top cover frame 20 having a through hole 25 arranged at its top for allowing the top cover 10 to be inserted; a bottom cover 40 having a nail-shaped object 46 arranged at its bottom and third baffles 42 which are provided with holes 43 to fit the clamping hooks 13 on the first baffles arranged at its top circumferentially; and a spring 30 located between the top cover 10 and the bottom cover 40.

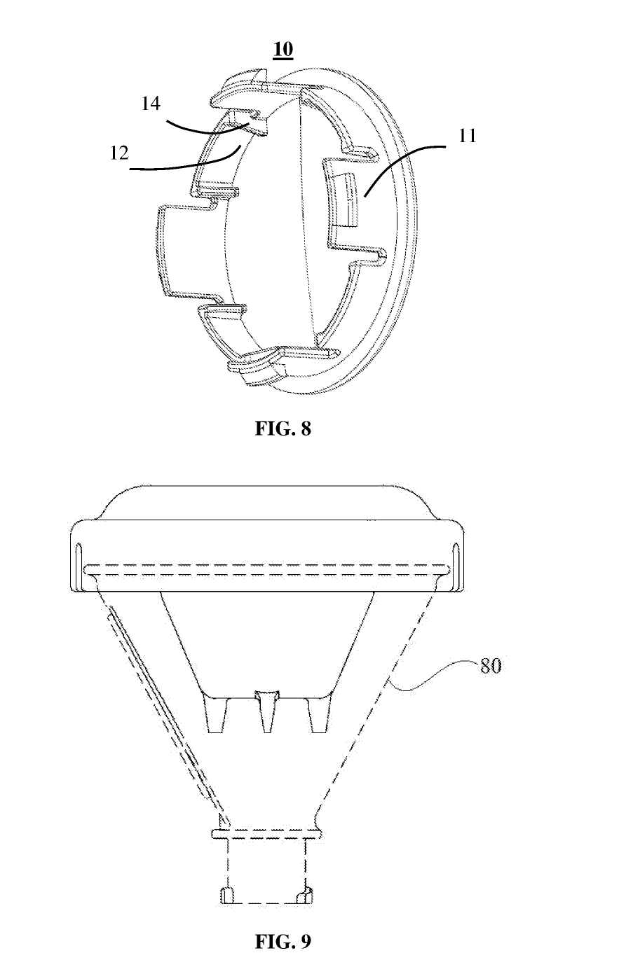

The top cover 10 is round, and provided with second baffles 12 at its bottom circumferentially. The second baffles 12 are spaced from the first baffles 11, and located on the inner side of the first baffles 11. The second baffles 12 and the first baffles 11 are coaxial circles. The two ends of the second baffles 12 may be connected to the ends of adjacent first baffles 11. In this embodiment, bending portions 14 as shown in FIG. 8 are arranged at the two ends of the second baffles 12, and bent towards the center of the top cover 10. The clamping hooks 13 on the first baffles 11 are used to buckle into the holes 43 on the third baffles 42 to realize coaxial rotation of the bottom cover and the top cover.

A plurality of support plates 21 is arranged on the inner wall of the through hole of the top cover frame 20 for supporting the top cover 10. The top cover 10 and the top cover frame 20 constitute the upper cover of the hand guard. Preferably, the bottom edge 23 of the top cover frame 20 is serrated. The top edge 44 of the bottom cover 40 is also serrated, which matches the bottom edge 23 of the top cover frame 20.

In this embodiment, fourth baffles 41 are arranged at the top of the bottom cover 40 circumferentially, corresponding to the second baffles 12, which are used to support the second baffles 12 to ensure the horizontality of the top cover 10 and its distance from the bottom cover 40. During implementation of the invention, as the clamping hooks 13 on the first baffles 11 need to be buckled into the holes 43 on the third baffles 42, i.e., the first baffles 11 correspond to the third baffles 42, the fourth baffles 41 are also spaced from the third baffles 42 and located on the inner side of the third baffles 42, and the two ends of the fourth baffles 41 may be connected to the ends of adjacent third baffles 42.

Further, a circular groove 45 is arranged at the top of the bottom cover 40 circumferentially to receive the spring 30. The circular groove 45 is located on the outer side of the third baffles 42.

The top cover frame in the hand guard for rotational slicing type food cutting device provided by the present invention is designed to be movable slightly up and down. As there is a spring between the top cover frame and the bottom cover, the top cover frame can be kept at the highest point when no pressure is applied on it.

The serrated edge at the bottom of the top cover frame matches the serrated edge at the top of the bottom cover so that when the user presses downward and rotates the upper cover of the hand guard clockwise, the top cover frame will drive the bottom cover to move, making the bottom cover and the top cover frame rotate coaxially in the same direction. When the user rotates the upper cover of the hand guard anti-clockwise, a separating effect will be generated between the top cover frame and the bottom cover, the bottom cover will remain unmoved, while the top cover frame may rotate freely anti-clockwise.

As shown in FIG. 7˜FIG. 9, a baffle 22 is arranged on the marginal sidewall of the top cover frame 20, and provided with a rib 24 on its inner wall. The baffle 22 on the top cover frame and the rib on the inner wall of the baffle 22 are for buckled fixation with the upper edge of the food cutting device 80. To be specific, the baffle 22 has certain resilience and constitutes a resilient clamping member. Under the action of the external force, the free end of the baffle 22 can move slightly outward along a radial direction and can be buckled with the upper edge of the food cutting device 80 via the rib 24 on the baffle 22, thereby mounting the hand guard on the food cutting device 80.

In the structure of the hand guard for rotational slicing type food cutting device provided by the present invention, the top cover, the top cover frame and the bottom cover are arranged coaxially.

The hand guard for rotational slicing type food cutting device provided by the present invention can operate in cooperation with the cutting device to enable a user to complete a wrist return action without loosening, thereby preventing deviation between a vegetable-fruit rotation shaft and an axis of the food cutting device, and breakage of food shreds. During use, the hand guard for rotational slicing type food cutting device should be coaxial with the food cutting device.

Above the preferred embodiments of the present invention are illustrated with reference to the accompanying drawings. Without departing from the scope and essence of the present invention, those skilled in the art may have various modified solutions to realize the present invention. For example, the features shown or described as part of one embodiment may be used in another embodiment to obtain one or more embodiment. The foregoing descriptions are preferred embodiments of the present invention and are not intended to limit the scope of the rights of the present invention. All the equivalent modifications made by using the content of the Description and accompanying drawing of the present invention are included in the scope of the appended claims.

What is claimed is:

1. A hand guard for rotational slicing type food cutting device, comprising:
a top cover having a plurality of first baffles having clamping hooks arranged thereon arranged at its bottom circumferentially;
a top cover frame having a through hole arranged at its top for allowing the top cover to be inserted;
a bottom cover having a nail-shaped object arranged at its bottom and third baffles which are provided with holes to fit the clamping hooks on the first baffles arranged at its top circumferentially; and
a spring located between the top cover and the bottom cover.

2. The hand guard according to claim 1, wherein the bottom edge of the top cover frame is serrated, the top edge of the bottom cover frame is serrated, and the serration of the bottom edge of the top cover frame matches the serration of the top edge of the bottom cover so that the top cover frame and the bottom cover can rotate clockwise coaxially in a same direction, while when the top cover frame rotates anti-clockwise, the bottom cover remains unmoved.

3. The hand guard according to claim 1, wherein second baffles are arranged at the bottom of the top cover circumferentially which are spaced from the first baffles, and are located on the inner side of the second baffles.

4. The hand guard according to claim 3, wherein the second baffles and the first baffles are coaxial circles.

5. The hand guard according to claim 3, wherein fourth baffles are arranged at the top of the bottom cover circumferentially, which correspond to the second baffles, and are used to support the second baffles to ensure the horizontality of the top cover and its distance from the bottom cover.

6. The hand guard according to claim 1, wherein a plurality of support plates is arranged on the inner wall of the through hole of the top cover frame for supporting the top cover.

7. The hand guard according to claim 1, wherein a baffle is arranged on the marginal sidewall of the top cover frame, which is provided with a rib on its inner wall for buckled fixation with the upper edge of the food cutting device.

8. The hand guard according to claim 1, wherein the top cover, the top cover frame and the bottom cover are arranged coaxially.
